(19) United States
(12) Patent Application Publication
(10) Pub. No.: US 2020/0259702 A1
(43) Pub. Date: Aug. 13, 2020

(54) METHOD AND SYSTEM FOR ESTABLISHING FAULT TOLERANT COMMUNICATION CHANNEL BETWEEN TERMINAL DEVICE AND TARGET SYSTEM

(71) Applicant: INNOVITI PAYMENT SOLUTIONS PRIVATE LIMITED, Bangalore, Karnataka (IN)

(72) Inventors: Rajeev AGRAWAL, Bangalore, Karnataka (IN); Hari Charan RAMACHANDRA RAO, Bangalore, Karnataka (IN); Phani Kumar G V, Bangalore, Karnataka (IN); Siva GANESHAN, Bangalore, Karnataka (IN); Kartik Chandrasekar IYER, Bangalore, Karnataka (IN)

(21) Appl. No.: 16/633,968

(22) PCT Filed: Jul. 24, 2018
(86) PCT No.: PCT/IB2018/055495

§ 371 Date: Jan. 24, 2020

(30) Foreign Application Priority Data
Jul. 25, 2017 (IN) 201741026002

(51) Int. Cl. H04L 12/24; H04L 12/26

(52) U.S. Cl. CPC H04L 41/0668; H04L 43/0811; H04L 41/0846

(57) ABSTRACT

Disclosed herein is a method and system for establishing fault tolerant communication channel between terminal device and target system. In an embodiment, the communication channel between terminal device and target system, through a primary communication gateway, is monitored for collecting state information related to communication channel and to detect fault in the primary communication gateway. The state information is stored in terminal device. Subsequently, upon detecting fault, a secondary communication gateway is selected and configured with the state information, thereby replacing the primary communication gateway, and re-establishing the communication channel between terminal device and target system through the secondary communication gateway. Thus, present disclosure discloses efficient approach for replicating state information related to communication channel to secondary communication gateways upon detecting fault in the primary communication gateway, thereby enhancing reliability and availability of the communication gateways for communication.

This non-provisional patent application claims priority from the Indian provisional patent application No.: 201741026002 dated 25 Jul. 2017.

### TECHNICAL FIELD

The present subject matter is in general related to communication channels and more particularly, but not exclusively, to a method and system for establishing a fault tolerant communication channel between a terminal device and a target system.

### BACKGROUND

Over the last several decades, Point-Of-Sale (POS) devices or Electronic Data Capture (EDC) terminals have become one of the most common means for performing a transaction. However, digital transaction mechanisms which include various entities like EDC terminals, communication channels and communication gateways encounter stability and availability related issues for various reasons. Generally, transactions become successful only when each of the above entities are fully functional and each of these entities represent a potential fault point for failure of the transactions.

EDC terminals, specifically the hardware and firmware of the EDC terminals, have evolved over time and are typically robust. Whenever there is a fundamental fault in the functioning of the EDC terminals, fault tolerance and high availability of the EDC terminals may be ensured by way of redundancy in machines, i.e. by instantly replacing the faulty EDC terminal with a functional EDC terminal. While there is a potential for the EDC firmware to be faulty, nothing much could be done beyond rectifying the faults over time and providing immediate resolve for the faults.

The faultiness and/or non-availability of the communication channels may be addressed with the use of variants of communication channels like Local Area Network (LAN), General Packet Radio Service (GPRS) and Public Switched Telephone Network (PSTN), Multiprotocol Label Switching (MPLS), Internet Protocol Security (IPSec) and the like. These variants may be appropriately employed for tiding over faults and ensuring fault tolerance in the communication channels.

However, there is enormous potential for the communication gateways to be unstable, given the amount of traffic they handle and high possibilities of errors occurring at software and/or hardware systems housing the communication gateways. Existing approaches propose redundancy technique to overcome stability and availability issues at the communication gateways. Achieving redundancy in the functioning of the communication gateway requires that the state information related to the communication being performed through the communication gateway is replicated across all redundant communication gateways. However, continuous replication of the state information across all the communication gateways has its costs in terms of time, network bandwidth and is error prone, which in turn affects the uninterrupted functioning of the communication gateways.

The information disclosed in this background of the disclosure section is only for enhancement of understanding of the general background of the invention and should not be taken as an acknowledgement or any form of suggestion that this information forms the prior art already known to a person skilled in the art.

### SUMMARY

One or more shortcomings of the prior art may be overcome, and additional advantages may be provided through the present disclosure. Additional features and advantages may be realized through the techniques of the present disclosure. Other embodiments and aspects of the disclosure are described in detail herein and are considered a part of the claimed disclosure.

Disclosed herein is a method for establishing a fault tolerant communication channel between a terminal device and a target system. The method comprises monitoring, by a communication manager, a communication channel between a terminal device and a target system. The terminal device communicates with the target system through a primary communication gateway selected from plurality of communication gateways associated with the terminal device. Further, the method comprises collecting state information related to the communication channel based on the monitoring of the communication channel. The state information is stored in a memory unit associated with the terminal device. Furthermore, the method comprises detecting a fault in the primary communication gateway based on the monitoring. Upon detecting the fault, the method comprises selecting a secondary communication gateway, from the plurality of communication gateways, for replacing the primary communication gateway. Finally, the method comprises configuring the secondary communication gateway with the state information corresponding to the communication channel for re-establishing the communication channel between the terminal device and the target system through the secondary communication gateway.

Further, disclosed herein is a communication manager for establishing a fault tolerant communication channel between a terminal device and a target system. The communication manager comprises a processor and a memory. The memory is communicatively coupled to the processor and stores processor-executable instructions, which on execution, cause the processor to monitor a communication channel between a terminal device and a target system. The terminal device communicates with the target system through a primary communication gateway selected from plurality of communication gateways associated with the terminal device. Further, the instructions cause the processor to collect state information related to the communication channel based on monitoring of the communication channel. The state information is stored in a memory unit associated with the terminal device. Furthermore, the instructions cause the processor to detect a fault in the primary communication gateway based on the monitoring. Upon detecting the fault, the instructions cause the processor to select a secondary communication gateway, from the plurality of communication gateways, for replacing the primary communication gateway. Finally, the instructions cause the processor to configure the secondary communication gateway with the state information corresponding to the communication channel to re-establish the communication channel between the terminal device and the target system through the secondary communication gateway.

Furthermore, disclosed herein is a terminal device comprising a control unit and a memory unit. The control unit is configured to receive a communication request for establishing a communication channel with the target system. Further, the control unit is configured to receive state information related to the communication channel and store the state information in the memory unit. The memory unit is communicatively associated with the control unit and stores state information related to the communication channel.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary environment for establishing fault tolerant communication channel between a terminal device and a target system in accordance with some embodiments of the present disclosure;

FIG. 2A shows a detailed block diagram of a communication manager in accordance with some embodiments of the present disclosure;

FIGS. 2B shows a detailed block diagram of a terminal device in accordance with some embodiments of the present disclosure;

FIG. 3 shows a flowchart illustrating a method of establishing a fault tolerant communication channel between a terminal device and a target system in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a communication manager for establishing a fault tolerant communication channel between a terminal device and a target system. The terminal device may connect to the target system through a communication gateway. The communication gateway may be hosted by a communication aggregator associated with the target system. Typically, when the device initiates a communication, several activities may be involved in establishing and maintaining the communication channel, which follow a ‘stateful’ communication model. In the ‘stateful’ communication model, ‘state information’ corresponding to the communication channel may be updated monotonically until completion of the communication. However, when the current communication gateway becomes non-functional, the state information needs to be sustained and carried forward to other functional communication gateways for completion of the communication.

Embodiments of the present disclosure disclose an effective approach for sharing the state information from the faulty and/or non-functional communication gateway to other functional communication gateways. Accordingly, the present disclosure discloses the aspect of storing the state information locally on the terminal device and replicating the state information only to a selected functional communication gateway for uninterrupted completion of the communication. Thus, the present disclosure avoids the need for replicating the state information to all the available functional communication gateways. As a result, the present disclosure helps in eliminating replication delays and reliability issues of underlying replication infrastructure. Also, the present disclosure eliminates costs in terms of time, and network resources.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

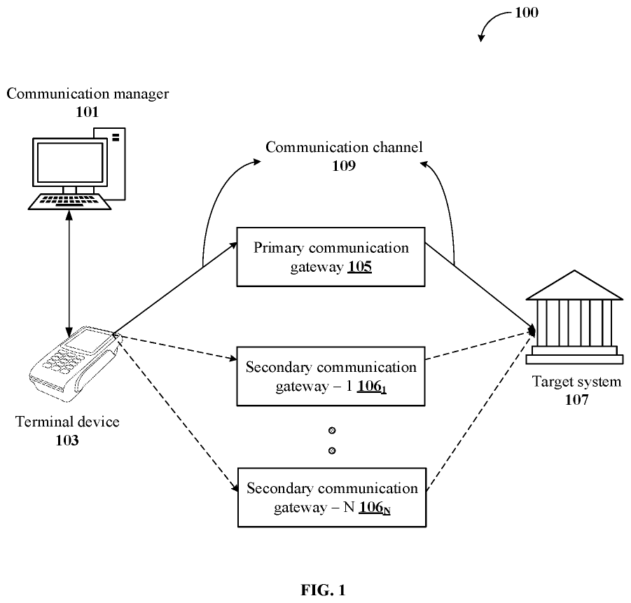

FIG. 1 shows an exemplary environment 100 for establishing fault tolerant communication channel 109 between a terminal device 103 and a target system 107 in accordance with some embodiments of the present disclosure.

In an embodiment, the environment 100 may include a communication manager 101, a terminal device 103, a primary communication gateway 105 and one or more secondary communication gateways 106₁-106_{N} (collectively referred to as secondary communication gateways 106), and a target system 107.

In an implementation, the communication manager 101 may be configured external to the terminal device 103 and communicatively coupled to the terminal device 103 (as shown in FIG. 1). In an alternative implementation, the communication manager 101 may be configured within the terminal device 103. The terminal device 103 may include, without limiting to, a Point-of-Sale (PoS) device, an Electronic Data Capture (EDC) terminal and the like, which may be used by a user in the environment 100 to initiate a communication with the target system 107. In an embodiment, the target system 107 may include, without limiting to, a communication server, a service provider, or financial institutions such as banks.

In an embodiment, the terminal device 103 may communicate with the target system 107 using a communication channel 109 that connects the terminal device 103 and the target system 107 through the primary communication gateway 105 or one of the secondary communication gateways 106. In an embodiment, the primary communication gateway 105 may represent a communication gateway which is selected for the communication when a new communication is initiated at the terminal device 103. On the other hand, the one or more secondary communication gateways 106 represent the communication gateways that may be used for the communication, when the primary communication gateway 105 becomes non-functional due to a fault in the primary communication gateway 105. That is, the one or more secondary communication gateways 106 may be used as back-up communication gateways for the primary communication gateway 105. This ensures uninterrupted communication between the terminal device 103 and the target system 107 even when the primary communication gateway 105 becomes non-functional. In an implementation, each of the one or more secondary communication gateways 106 may be pre-configured in the terminal device 103.

In an embodiment, the primary communication gateway 105 and the secondary communication gateways 106 may include, without limitation, any data communication device that may be capable of setting up a remote network connectivity between the terminal device 103 and the target system 107. As an example, in case of communication requests relating to financial transactions, the primary communication gateway 105 and the secondary communication gateways 106 may be payment gateways hosted by a payment aggregator. In an implementation, the primary communication gateway 105 and each of the one or more secondary communication gateways 106 may be located and/or from a single geographical location. In another implementation, the primary communication gateway 105 and each of the one or more secondary communication gateways 106 may be hosted from a plurality of distinct geographical locations. Hosting the communication gateways on distinct geographical locations ensures that at least one of the communication gateways remain functional even when there is a physical damage/fault in one of the geographical locations.

In an embodiment, a communication may be initiated at the terminal device 103 when the user or an operator of the terminal device 103 generates a communication request at the terminal device 103. As an example, the communication request may be generated when the user/operator swipes his/her debit card at the terminal device 103 for making a payment. Once the communication is initiated at the terminal device 103, the terminal device 103 may register itself with a communication gateway specified in the communication request, i.e. the primary communication gateway 105. Thereafter, the primary communication gateway 105 may establish a communication channel 109 between the terminal device 103 and the target system 107 for completing the communication between the terminal device 103 and the target system 107.

In an embodiment, the communication manager 101 may constantly monitor the communication channel 109 and collect state information related to the communication channel 109. As an example, the state information may include, without limiting to, a unique communication identifier (communication ID), a communication batch serial number and a System Trace Audit Number (STAN) corresponding to the communication channel 109. Further, the communication manager 101 may store the collected state information in a memory unit associated with the terminal device 103. Additionally, the communication manager 101 may also constantly monitor the communication channel 109 to detect faults in the primary communication gateway 105, before completion of the communication between the terminal device 103 and the target system 107.

In an embodiment, the communication manager 101 may detect faults in the primary communication gateway 105 using a known fault detection technique. As an example, one of the fault detection techniques could be based on communication timeout window. That is, the communication manager 101 may detect a fault when no response is received from the primary communication gateway 105 within a specified timeout window. In an embodiment, beyond the specified timeout window, the communication manager may assume that the primary communication gateway 105 is non-functioning and may proceed for a activating a different communication gateway.

In an embodiment, when a fault is detected at the primary communication gateway 105 and/or when the primary communication gateway 105 becomes non-functional due to a fault at the primary communication gateway 105, the communication manager 101 may select one of the one or more secondary communication gateways 106 as a replacement for the primary communication gateway 105. In an implementation, selection of one of the one or more secondary communication gateways 106 may be based on a predetermined selection technique. As an example, the predetermined selection technique may be round-robin selection technique.

In an embodiment, upon selecting one of the one or more secondary communication gateways 106, the communication manager 101 may configure selected one of the secondary communication gateways 106 using the state information stored in the memory unit associated with the terminal device 103. That is, the communication manager 101 may replicate the state information stored at the terminal device 103 into selected one of the secondary communication gateways 106 for replacing the primary communication gateway 105. In an embodiment, once the selected one of the secondary communication gateways 106 is configured with the state information, it may become functional and re-establish the communication between the terminal device 103 and the target system 107. In other words, configuring the selected one of the secondary communication gateways 106 with the state information ensures that the selected one of the secondary communication gateways 106 becomes functional from a most recent communication state completed by the primary communication gateway 105.

Finally, the communication between the terminal device 103 and the target system 107 may be accomplished using the re-established communication channel 109 between the terminal device 103 and the target system 107, through the selected one of the secondary communication gateways 106. In an embodiment, the communication manager 101 may constantly monitor the re-established communication channel 109 for collecting the state information corresponding to the re-established communication channel 109. Also, the communication manager 101 may update and/or store the collected state information in the memory unit of the terminal device 103. Subsequently, if a fault is detected in the selected one of the secondary communication gateways 106, the communication manager 101 may select and configure the primary communication gateway 105 (which is rectified for all the faults) or one of the secondary communication gateways 106 to re-establish the communication channel 109. The communication manager 101 may re-execute the above process until the communication between the terminal device 103 and the target system 107 is completed.

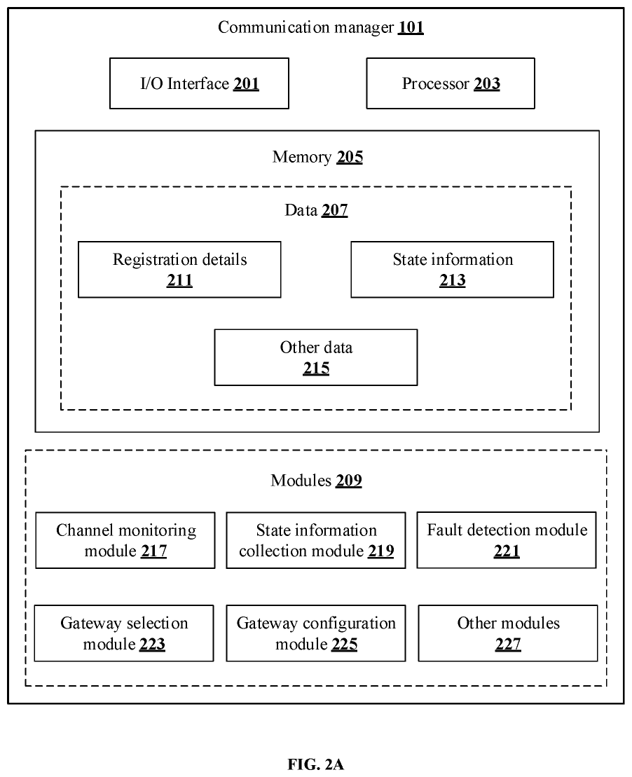

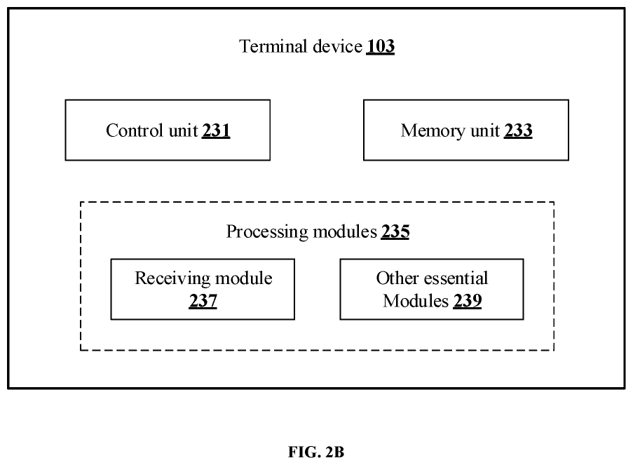

FIG. 2A shows a detailed block diagram of a communication manager 101 in accordance with some embodiments of the present disclosure.

In an implementation, the communication manager 101 may include an I/O interface 201, a processor 203, and a memory 205. The I/O interface 201 may be configured to communicate with a terminal device 103. The processor 203 may be configured to perform one or more functions of the communication manager 101 while establishing a fault tolerant communication channel 109 between the terminal device 103 and a target system 107. The memory 205 may be communicatively coupled to the processor 203 and may store data 207.

In some implementations, the communication manager 101 may operate one or more modules 209 using the data 207 for performing various operations in accordance with embodiments of the present disclosure. In an embodiment, the data 207 may be stored within the memory 205 and may include, without limiting to, registration details 211, state information 213 and other data 215.

In some implementations, the data 207 may be stored within the memory 205 in the form of various data structures. Additionally, the data 207 may be organized using data models, such as relational or hierarchical data models. The other data 215 may store various data, including network information, user information and other temporary data and files generated by one or more modules 209 for performing various functions of the communication manager 101.

In an embodiment, the registration details 211 may include all information exchanged between the terminal device 103 and the primary communication gateway 105 and/or the one or more secondary communication gateways 106 while establishing the communication channel 109. For instance, each time a new secondary communication gateway 106 is selected and configured by the communication manager 101, the terminal device 103 may register itself with the selected one of the secondary communication gateways 106 by exchanging the registration details 211. Further, the selected one of the secondary communication gateways 106 may allow the terminal device 103 to take part in the communication only upon successful verification of the registration details 211. As an example, the registration details 211 may include, without limiting to, a terminal device identifier (terminal ID), the communication ID, a target system identifier (target ID) and other credentials of the user who has generated the communication request at the terminal device 103.

In an embodiment, the state information 213 may include information corresponding to each state of the communication between the terminal device 103 and the target system 107 using the communication channel 109. As an example, the state information 103 may include, without limiting to, System Trace Audit Number (STAN), batch serial number, unique communication identifier associated with the target system 107, and additional information like communication server identifiers associated with the target system 107. In an embodiment, each ‘state’ of the communication may be executed in a sequential manner. Thus, upon completion of each ‘state’ of the communication, the state information 213 may be dynamically updated to reflect changes in the ‘state’ of the communication. Thus, at any given time, the state information 213 reflects a latest ‘state’ of the communication through the communication channel 109. Therefore, during faults in the primary communication gateway 105, the state information 213 may be used to configure one of the secondary communication gateways 106 to operate from a most recent successful ‘state’ of the communication. As a result, there may not be any interruptions in the communication even when the primary communication gateway 105 is replaced by one of the secondary communication gateways 106.

In an embodiment, each of the data 207 stored in the memory 205 may be processed by one or more modules 209 of the communication manager 101. In one implementation, the one or more modules 209 may be stored as a part of the processor 203. In another implementation, the one or more modules 209 may be communicatively coupled to the processor 203 for performing one or more functions of the communication manager 101. The modules 205 may include, without limiting to, a channel monitoring module 217, a state information collection module 219, a fault detection module 221, a gateway selection module 223, a gateway configuration module 225 and other modules 227.

As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 227 may be used to perform various miscellaneous functionalities of the communication manager 101. It will be appreciated that such modules 209 may be represented as a single module or a combination of different modules.

In an embodiment, the channel monitoring module 217 may be configured for constantly monitoring the communication channel 109 between the terminal device 103 and the target system 107 until completion of the communication. The channel monitoring module 217 may also be configured for monitoring the re-established communication channel 109 between the terminal device 103 and the target system 107 through one of the secondary communication gateways 106.

In an embodiment, the state information collection module 219 may be configured for collecting the state information 213 corresponding to the communication channel 109 throughout the communication. As an example, the state information 213 collected by the state information collection module 219 may include, without limiting to, the communication ID, a communication batch serial number, and a System Trace Audit Number (STAN) corresponding to the communication channel 109. Further, the state information collection module 219 may also be configured for dynamically updating the state information 213 upon determining a change in the ‘state’ of communication. In an implementation, the state information 213 collected by the state information collection module 219 may be stored in a memory unit of the terminal device 103.

In an embodiment, the fault detection module 221 may be configured for detecting faults in the primary communication gateway 105 based on monitoring of the communication channel 109. The faults in the primary communication gateway 105 may include operational conditions that cause the primary communication gateway 105 to become non-functional before completion of the communication. As an example, one such fault condition may be physical damage at the primary communication gateway 105. In an embodiment, the fault detection module 221 may also be configured for detecting faults in the one or more secondary communication gateways 106 which are used for re-establishing the communication channel 109 during failure of the primary communication gateway 105.

In an embodiment, the gateway selection module 223 may be configured for selecting one of the one or more secondary communication gateways 106 as a replacement for the primary communication gateway 105 when a fault is detected in the primary communication gateway 105. In some implementations, the gateway selection module 223 may use a predetermined selection logic such as round robin selection logic for selecting one of the one or more secondary communication gateways 106. For example, suppose there 4 communication gateways C1, C2, C3 and C4 in the environment 100. Suppose, C1 is the primary communication gateway 105 and C2-C4 are the secondary communication gateways 106. Here, when C1 becomes non-functional due to a fault, the gateway selection module 223 may execute the predetermined selection logic for selecting one among C2, C3 and C4 as the secondary communication gateway. In an embodiment, the communication gateway C1 may also be made available for selection, after C1 is rectified for the faults occurred in the initial instance.

In an embodiment, the gateway configuration module 225 may be used for configuring the selected one of the secondary communication gateways 106 with the state information 213 corresponding to the communication channel 109. After the configuration, the selected one of the secondary communication gateways 106 may become functional and re-establish the communication channel 109 as if it were the primary communication gateway 105. Thus, the end user experiences an uninterrupted communication between the terminal device 103 and the target system 107.

FIG. 2B shows a detailed block diagram of a terminal device 103 in accordance with embodiments of the present disclosure.

In an embodiment, the terminal device 103 may be an electronic device such as a Point-of-Sale (PoS) device or an Electronic Data Capture (EDC) terminal, which enables a user to initiate a communication request. In some implementations, the terminal device 103 may include a control unit 231, a memory unit 233 and one or more processing modules 235.

The control unit 231 may be configured to control and coordinate overall functioning of the terminal device 103 using control data stored in the memory unit 233 and execute the one or more processing modules 235. In an implementation, the one or more processing modules 235 may include, without limiting to, a receiving module 237 and other essential modules 239.

The receiving module 237 may be configured to receive a communication request from a user and/or an operator of the terminal device 103, for example, when the user/operator swipes a payment card through the terminal device 103. The communication request thus received may be subsequently validated by the control unit 231 for establishing a communication channel 109 with a target system 107 specified in the communication request. Additionally, the receiving module 237 may be used for receiving state information 213 corresponding to the communication channel 109 from a communication manager 101, for example the communication manager 101 indicated in FIG. 1. In an embodiment, the state information 213 received from the communication manager 101 may be stored in the memory unit 233.

In an embodiment, other essential modules 239 may include a power management unit, a storage controller, a user interface, and other wired and/or wireless network interfaces that enable the terminal device 103 to communicate with the communication manager 101 and the communication gateways.

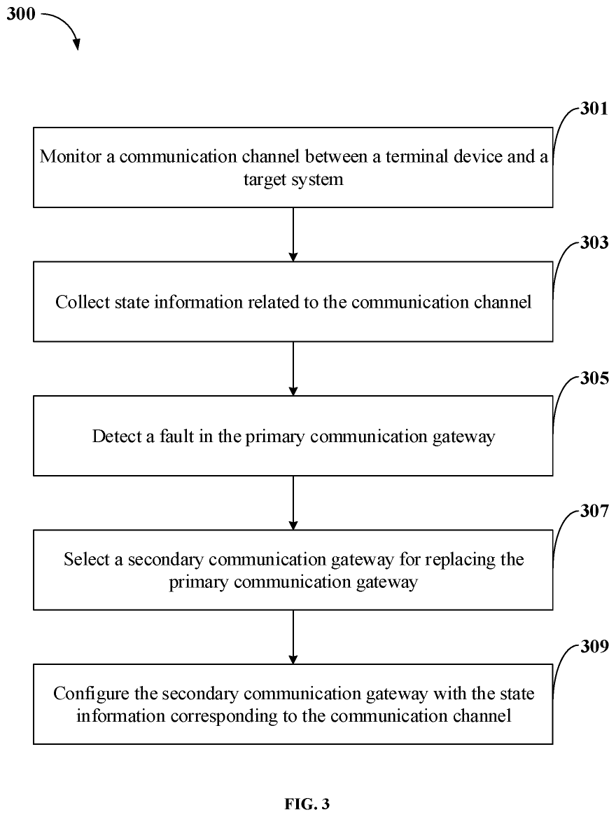

FIG. 3 shows a flowchart illustrating a method of establishing a fault tolerant communication channel 109 between a terminal device 103 and a target system 107 in accordance with some embodiments of the present disclosure.

As illustrated in FIG. 3, the method 300 may include one or more blocks illustrating a method of establishing a fault tolerant communication channel 109 between a terminal device 103 and a target system 107 using a communication manager 101 shown in FIG. 1. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the method 300 includes monitoring, by the communication manager 101, a communication channel 109 between the terminal device 103 and the target system 107. In an embodiment, the terminal device 103 may communicate with the target system 107 through a primary communication gateway 105 selected from plurality of communication gateways associated with the terminal device 103. In an implementation, each of the plurality of communication gateways may be hosted from at least one of a single geographical location or one or more distinct geographical locations.

At block 303, the method 300 includes collecting, by the communication manager 101, state information 213 related to the communication channel 109 based on the monitoring of the communication channel 109. In an embodiment, the state information 213 may be stored in a memory unit 233 associated with the terminal device 103. As an example, the state information 213 may include, without limiting to, System Trace Audit Number (STAN), communication batch serial number and a communication identifier corresponding to the communication channel 109.

At block 305, the method 300 includes detecting, by the communication manager 101, a fault in the primary communication gateway 105 based on the monitoring. As an example, the fault may be a condition which causes non-functioning of the communication gateway.

At block 307, the method 300 includes selecting, by the communication manager 101, a secondary communication gateway from the plurality of secondary communication gateways 106 for replacing the primary communication gateway 105, upon detecting a fault in the primary communication gateway 105.

At block 309, the method 300 includes configuring, by the communication manager 101, the selected one of the secondary communication gateways 106 with the state information 213 corresponding to the communication channel 109 for re-establishing the communication channel 109 between the terminal device 103 and the target system 107 through the selected one of the secondary communication gateways 106. In an embodiment, re-establishing the communication channel 109 between the terminal device 103 and the target system 107 may include registering the terminal device 103 with the selected one of the secondary communication gateways 106 selected from the plurality of communication gateways.

Computer System

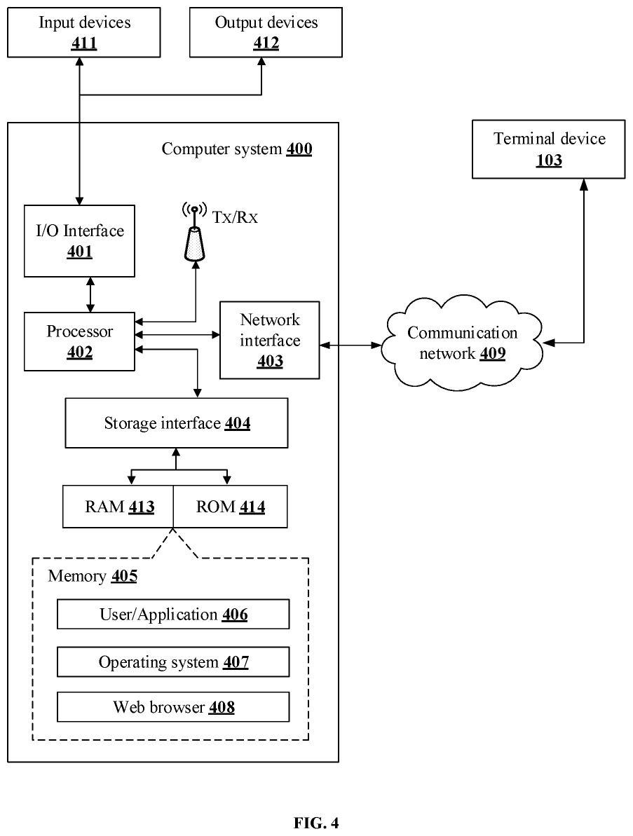

FIG. 4 illustrates a block diagram of an exemplary computer system 400 for implementing embodiments consistent with the present disclosure. In an embodiment, the computer system 400 may be communication manager 101 shown in FIG. 1, which may be used for establishing a fault tolerant communication channel 109 between a terminal device 103 and a target system 107. The computer system 400 may include a central processing unit (“CPU” or “processor”) 402. The processor 402 may comprise at least one data processor for executing program components for executing user- or system-generated business processes. A user may include a person, a user in the computing environment 100, a person initiating transaction or communication at the terminal device 103 or any system/sub-system being operated parallelly to the computer system 400. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n /b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 401, the computer system 400 may communicate with one or more I/O devices 411 and 412. In some implementations, the I/O interface 401 may be used to connect to the terminal device 103 such as a Point-of-Sale device or an Electronic Data Capture (EDC) terminal device.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may connect to the terminal device 103.

In an implementation, the communication network 409 can be implemented as one of the several types of networks, such as intranet or Local Area Network (LAN) and such within the organization. The communication network 409 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application interface 406, an operating system 407, a web browser 408, and the like. In some embodiments, computer system 400 may store user/application data 406, such as the data, variables, records, etc. as described in this invention. Such databases may be implemented as fault-tolerant, relational, scalable, secure databases such as Oracle® or Sybase®.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS , or the like.

The user interface 406 may facilitate display, execution, interaction, manipulation, or operation of program components through textual or graphical facilities. For example, the user interface 406 may provide computer interaction interface elements on a display system operatively connected to the computer system 400, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., Aero, Metro, etc.), web interface libraries (e.g., ActiveX®, JAVA®, JAVASCRIPT®, AJAX, HTML, ADOBE® FLASH®, etc.), or the like.

The web browser 408 may be a hypertext viewing application. Secure web browsing may be provided using Secure Hypertext Transport Protocol (HTTPS), Secure Sockets Layer (SSL), Transport Layer Security (TLS), and the like. The web browsers 408 may utilize facilities such as AJAX, DHTML, ADOBE® FLASH®, JAVASCRIPT®, JAVA®, Application Programming Interfaces (APIs), and the like. Further, the computer system 400 may implement a mail server stored program component. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein.

In an embodiment, the present disclosure discloses a method for establishing a fault tolerant communication channel between a terminal device and a target system.

In an embodiment, the present disclosure discloses an efficient approach for replicating state information related to the communication channel to alternative functional communication gateways upon detecting fault in a primary communication gateway.

In an embodiment, the method of present disclosure enhances reliability and availability of the communication gateways for a communication.

In an embodiment, the method of present disclosure may be used for uninterruptedly accomplishing financial transactions even when a payment gateway becomes non-functional before completion of the transactions.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Environment |
| 101 | Communication manager |
| 103 | Terminal device |
| 105 | Primary communication gateway |
| 106₁-106_{N} | Secondary communication gateways |
| 107 | Target system |
| 109 | Communication channel |
| 201 | I/O interface |
| 203 | Processor |
| 205 | Memory |
| 207 | Data |
| 209 | Modules |
| 211 | Registration details |
| 213 | State information |
| 215 | Other data |
| 217 | Channel monitoring module |
| 219 | State information collection module |
| 221 | Fault detection module |
| 223 | Gateway selection module |
| 225 | Gateway configuration module |
| 227 | Other modules |
| 231 | Control unit of the terminal device |
| 233 | Memory unit of the terminal device |
| 235 | Processing modules |
| 237 | Receiving module |
| 239 | Other essential modules |
| 400 | Exemplary computer system |
| 401 | I/O Interface of the exemplary computer system |
| 402 | Processor of the exemplary computer system |
| 403 | Network interface |
| 404 | Storage interface |
| 405 | Memory of the exemplary computer system |
| 406 | User/Application |
| 407 | Operating system |
| 408 | Web browser |
| 409 | Communication network |
| 411 | Input devices |
| 412 | Output devices |
| 413 | RAM |
| 414 | ROM |

1. A method for establishing a fault tolerant communication channel between a terminal device and a target system, the method comprising:
monitoring, by a communication manager, a communication channel between a terminal device and a target system, wherein the terminal device communicates with the target system through a primary communication gateway selected from plurality of communication gateways associated with the terminal device;
collecting, by the communication manager, state information related to the communication channel based on the monitoring of the communication channel, wherein the state information is stored in a memory unit associated with the terminal device;
detecting, by the communication manager, a fault in the primary communication gateway based on the monitoring;
selecting, by the communication manager, a secondary communication gateway, from the plurality of communication gateways, for replacing the primary communication gateway; and
configuring, by the communication manager, the secondary communication gateway with the state information corresponding to the communication channel for re-establishing the communication channel between the terminal device and the target system through the secondary communication gateway.

2. The method as claimed in claim 1, wherein each of the plurality of communication gateways are hosted from at least one of a single geographical location or one or more distinct geographical locations.

3. The method as claimed in claim 1, wherein the state information comprises a communication identifier, a communication batch serial number and a System Trace Audit Number (STAN) corresponding to the communication channel.

4. The method as claimed in claim 1 further comprises registering the terminal device with the primary communication gateway for establishing the communication channel with the target system.

5. The method as claimed in claim 1, wherein re-establishing the communication channel between the terminal device and the target system comprises registering the terminal device with the secondary communication gateway selected from the plurality of communication gateways.

6. A communication manager for establishing a fault tolerant communication channel between a terminal device and a target system, the communication manager comprises:
a processor; and
a memory, communicatively coupled to the processor, wherein the memory stores processor-executable instructions, which on execution, cause the processor to:
monitor a communication channel between a terminal device and a target system, wherein the terminal device communicates with the target system through a primary communication gateway selected from plurality of communication gateways associated with the terminal device;
collect state information related to the communication channel based on monitoring of the communication channel, wherein the state information is stored in a memory unit associated with the terminal device;
detect a fault in the primary communication gateway based on the monitoring;
select a secondary communication gateway, from the plurality of communication gateways, for replacing the primary communication gateway; and
configure the secondary communication gateway with the state information corresponding to the communication channel to re-establish the communication channel between the terminal device and the target system through the secondary communication gateway.

7. The communication manager as claimed in claim 6, wherein each of the plurality of communication gateways are hosted from at least one of a single geographical location or one or more distinct geographical locations.

8. The communication manager as claimed in claim 6, wherein the state information comprises a communication identifier, a communication batch serial number and a System Trace Audit Number (STAN) corresponding to the communication channel.

9. The communication manager as claimed in claim 6, wherein the processor is further configured to register the terminal device with the primary communication gateway to establish the communication channel with the target system.

10. The communication manager as claimed in claim 6, wherein the processor is further configured to register the terminal device with the secondary communication gateway to re-establish the communication channel with the target system.

11. A terminal device comprising:
a control unit, wherein the control unit is configured to:
receive a communication request for establishing a communication channel with the target system; and
receive state information related to the communication channel and store the state information in a memory unit associated with the terminal device; and
the memory unit, communicatively associated with the control unit, wherein the memory unit stores state information related to the communication channel.
